(19) United States
(12) Patent Application Publication
(10) Pub. No.: US 2015/0314303 A1
(43) Pub. Date: Nov. 5, 2015

(54) Device For The Magnetic Treatment Of A Hydrocarbon-Containing Fluid

(71) Applicant: Maria Michaela BARILITS-GUPTA, Drassburg (AT)

(72) Inventor: Maria Michaela BARILITS-GUPTA, Drassburg (AT)

(21) Appl. No.: 14/648,248

(22) PCT Filed: Nov. 8, 2013
(86) PCT No.: PCT/AT2013/000188

§ 371 Date: May 28, 2015

(30) Foreign Application Priority Data
Nov. 28, 2012 (AT) A 1254/2012

(51) Int. Cl. B03C 1/14; F02M 27/04; H01F 7/02

(52) U.S. Cl. CPC B03C 1/14; H01F 7/0294; F02M 27/045; B03C 2201/22; B03C 2201/30

(57) ABSTRACT

A device for a magnetic treatment of a hydrocarbon-containing fluid, which device has a pipe for the fluid to flow through and six magnets, which form three pairs located one after the other, the magnetic fields of which penetrate the interior of the pipe. The magnets are essentially cylindrical and are located outside the pipe, the two magnets of one pair being located in alignment with one another on opposite sides of the pipe wall and each pointing with one of its face ends to the pipe, and each magnet having a line pattern of alternating magnetic polarization, which is oriented perpendicular to the flow direction of the fluid.

The invention relates to a device for a magnetic treatment of a hydrocarbon-containing fluid, which device has a pipe for the fluid to flow through and six magnets, which form three pairs located one after the other, the magnetic fields of which penetrate the interior of the pipe.

Treating fossil fuels for vehicle motors by means of magnetic fields is known in the prior art. U.S. Pat. No. 6,456,178 B1, KR 10-2009-0011385 A, U.S. Pat. No. 5,348,050, WO 97/29279 and AT 010455 U1 teach various devices which, by means of a simple arrangement of a few permanent magnets, treat the fuel for internal combustion engines shortly before it is injected into the combustion chamber. In the process, the fuel passes longitudinally or transversely through a non-homogeneous magnetic field, as a result of which the carbon atoms are meant to be excited.

US 2007/0138077 A1, WO 02/101224 A1 and EP 0399 801 A1 show similar devices for magnetic activation of fuels, but they have a more-complicated construction. Many magnets are located, together with other devices, such as flow baffles or heating elements, inside a container through which fuel flows, so that the fuel is processed in various ways. The disadvantages of these versions are that not all the fuel quantities experience the same effect of the magnetic fields or other treatment elements and that the devices cannot be replaced without opening the entire fuel line.

U.S. Pat. No. 4,050,426 A discloses a method and a device for treating liquid fuel. In it, fuel flows closely along the inside surfaces of permanent magnets that are embodied as hollow cylinders. A disadvantage here is again that the device forms part of the fuel line, and thus the fuel line has to be opened if the device is to be changed or built in. Moreover, the fuel has to pass through two perforated baffles in order to flow into a jacket conduit of a double-walled hollow cylinder. This makes the manufacture of this device complicated.

DE 35 03 691 A1 describes a magnet activator for fuels, in which outside the rectilinear fuel line, there are three pairs of permanent magnets. In this teaching, the three magnetic fields through which the fuel passes, which are kept simple, also has a disadvantageous effect. Although activation of the hydrocarbons in the fuel is ascertainable, nevertheless it is comparatively slight.

The invention has the object of creating a device, as described at the outset above, which is simple in construction, requires only easy maintenance or needs hardly any maintenance, and is easy to build in or replace. Moreover, the device of the invention should achieve an improved, increased activation of the fluid.

The device of the invention attains this in that that the magnets are embodied essentially cylindrically and are located outside the pipe, the two magnets of one pair being located in alignment with one another on opposite sides of the pipe wall and each pointing with one of its face ends to the pipe, and each magnet having a line pattern of alternating magnetic polarization, which is oriented perpendicular to the flow direction of the fluid.

In one embodiment of the invention, the device has at least one further group of three pairs of magnets.

For further embodiment of the invention, the magnets are located in a housing, which is preferably tubular.

In a feature of the invention, it is preferable that the magnets are fixed in their position with plastic pieces.

A preferred embodiment of the invention is distinguished in that the axes of two pairs of magnets arranged one after the other, viewed in the flow direction, form an angle.

In a further embodiment, the magnets are disposed in a drum, which is supported axially rotatably on the pipe, and the drum is connected to an electric drive.

Preferably, the drive of the drum is regulated by a controller.

Also preferably, the controller is connected to at least sensor, by which the activation of the fluid can be measured.

The invention will be described below in further detail in terms of an exemplary embodiment shown in the drawings. In the drawings:

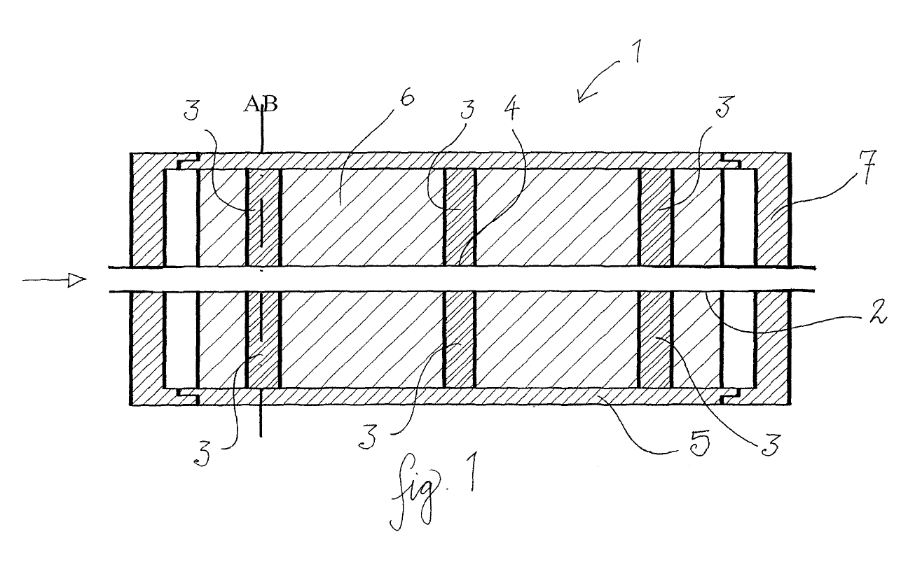

FIG. 1 is a schematic longitudinal section through the device;

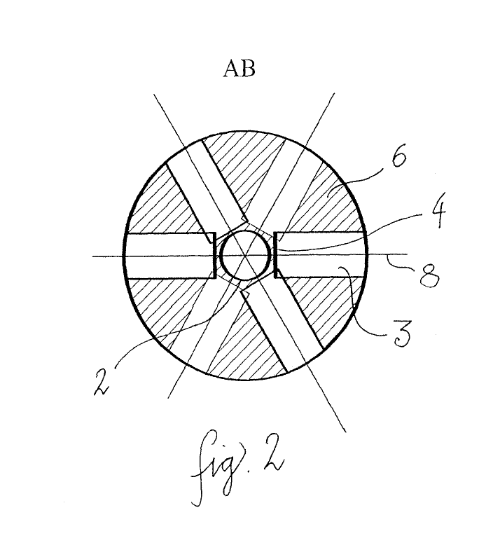

FIG. 2 is a schematic cross section through a further embodiment of the device;

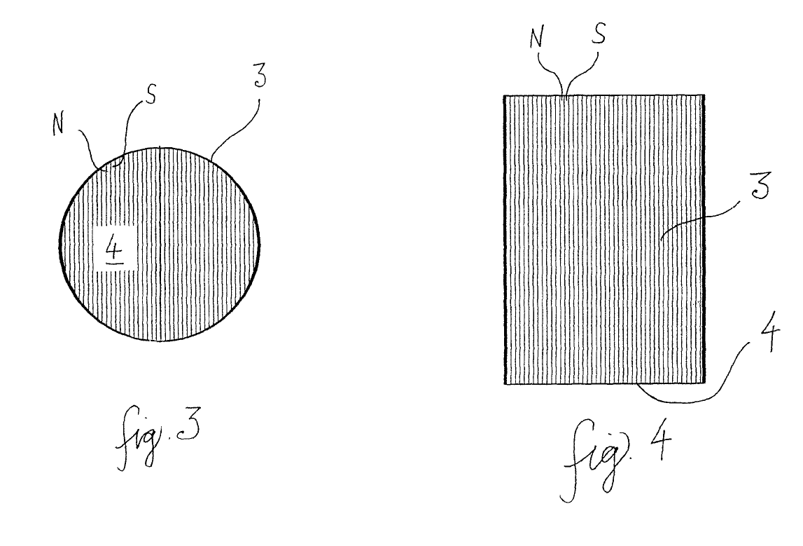

FIG. 3 is a schematic top view on a magnet;

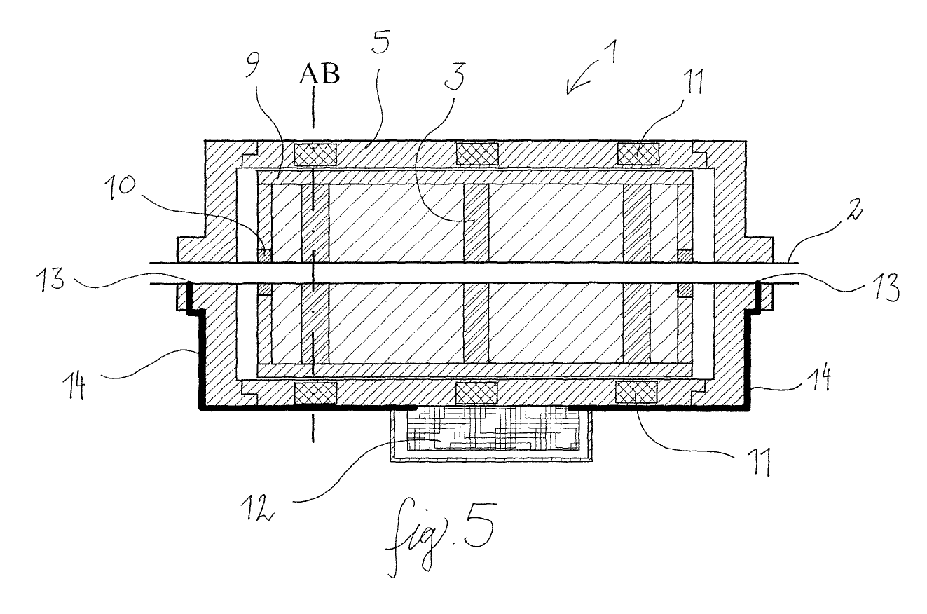

FIG. 4 is a schematic longitudinal section through a magnet;

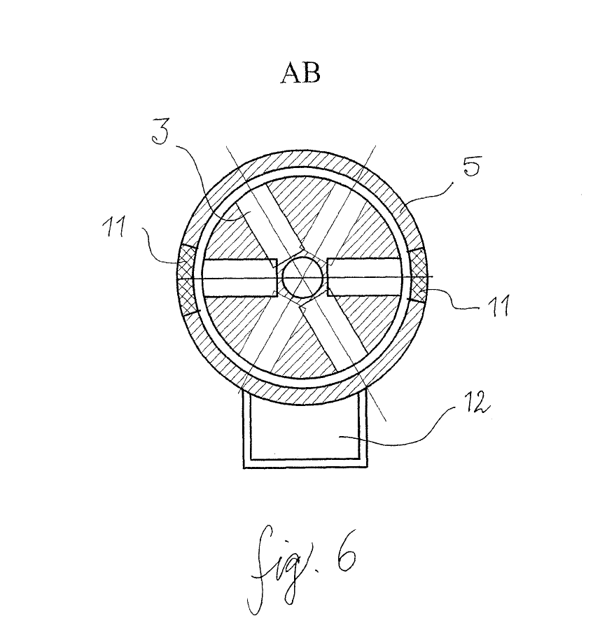

FIG. 5 is a schematic longitudinal section through the device; and

FIG. 6 is a schematic cross section through the device.

According to FIG. 1, a hydrocarbon-containing fluid flows in the direction of the arrow through a pipe 2. All known fossil, liquid or gaseous fuels, such as gasoline, heating oil, kerosene, natural gas, and the like are hydrocarbon-containing fluids. On flowing through the pipe 2, the fluid passes three pairs of magnets 3. Each of the magnets 3 is embodied as a permanent magnet and is aimed at the pipe 2 but is located outside the pipe. The polarization of the magnets 3 is selected such that a north pole of a first magnet 3 is always located opposite a south pole of the oppositely located magnet 3, and vice versa. Instead of permanent magnets, electromagnets or other types of magnets may also be used.

When hydrocarbons are combusted in engines, burners, furnaces, or the like, the performance is best if the carbon atoms and the hydrogen atoms combust together with the oxygen from the air completely to form carbon dioxide (CO₂) and water (H₂O). The prerequisite for this is not only the appropriate mixture ratio of fluid and oxygen from the air and the most uniform possible atomization of the fluid in the oxygen from the air at the instant of combustion, but also the best state of the bonded carbon atoms in the hydrocarbons prior to combustion. That is, if of the four valence electrons of a carbon atom that are taking part in the reaction, not all of them are in the excited state, then despite the presence of sufficiently many oxygen atoms, it can happen that the carbon combusts only into carbon monoxide (CO), or remains uncombusted, in the form of soot. This lowers the performance of the internal combustion engine or heating system, and the expulsion of unwanted carbon monoxide and soot particles is increased. Surprisingly, the location and the polarization of the magnets 3 in accordance with the present invention creates a device in which carbon atoms are activated to a particularly high extent by hydrocarbons, so that in the ensuing combustion with oxygen they react to form carbon dioxide.

Moreover, as shown in FIG. 1 and FIGS. 3 and 4, the magnets 3 are embodied as cylindrical bar magnets. Their circular face ends 4 are each aimed at the pipe 2. For the sake of simple, safe handling, the three pairs of magnets are located in a housing 5. To keep them in their exact position, the magnets 3 are retained by plastic pieces 6. In the example shown, they are shaped in such a way that they almost completely fill up the interior of the housing 5 and have only mill-cut or drilled hollow chambers for receiving the magnets 3. The plastic pieces 6 can of course also be made from some other solid material, as long as it does not affect the magnetic fields of the magnets 3. Preferably, the housing 5 is tubular and is oriented coaxially with the pipe 2. The housing 5 preferably comprises Stg. 37 and is chromium-plated on the outside. It can have a thread on both ends that serves to screw in caps 7 onto it. Still other kinds of construction of the housing for storing and fixed retention of the magnets 3 are conceivable, such as two half-shells that can be closed over an existing pipe 2. If end caps 7 are provided, then they too, like the housing 5, are made from Stg. 37. In terms of their dimensions, the housing 5 and end caps are designed such that no magnetic saturation is attained by the magnets 3, so that the magnetic circuit is closed, and the magnetic field reaches its greatest field intensity precisely where it is needed. The pipe 2 can be made from special steel, because special steel is paramagnetic.

FIG. 2 shows a cross section of the device 1 along the line AB of FIG. 1. In FIG. 2, two magnets 3 face one another on a common axis 8 and point with their face ends 4 to the pipe 2.

FIG. 3 shows the precise polarization of the magnets 3. In a line pattern, the north and south poles alternate with one another (in FIG. 3, as an example, two lines are identified as the north pole N and the south pole S). The corresponding magnet 3 on the opposite side of the pipe 2 has the same line pattern, but with reverse polarization. As a result, an alternating magnetic field is set up inside the pipe 2. Surprisingly, it is demonstrated that, given a suitable frequency of the magnetic field alternation, enhanced activation of the carbon atoms takes place. The frequency of alternation is dictated essentially by the three-dimensional spacing of the north and south poles on the magnets 3 and by the flow speed of the fluid through the pipe 2.

In FIG. 4 as well, the line pattern has the alternating north and south polarization on one magnet 3; in this longitudinal sectional view, the face end 4 points downward.

Tests have shown that the efficiency of the device 1 can be increased by providing that three pairs of magnets are used; the spacing between the first and the second pair and the spacing between the second and the third pair of magnets 3 is chosen to be equal. A further increase in efficiency significantly takes place whenever a further group of three pairs of magnets 3 is added to the first group. It has also surprisingly been found that the efficiency of the device is enhanced if the axes 8 of two pairs of magnets located one after the other form an angle (FIG. 2). Two magnets 3 of a pair, which are located opposite one another around the pipe 2, are oriented in alignment with one another; that is, they are located along a common axis 8, which is perpendicular to the flow direction 2 that is determined by the pipe 2. Viewed in the flow direction, the axes 8 of two adjacent pairs of magnets can now form an angle.

FIG. 5 shows a further embodiment of the invention. By means of a simple change, the efficiency for activating the fluid is increased. To that end, the three pairs of magnets 3 are located in a drum 9 inside the housing 5. The drum 9 is supported coaxially rotatably on the pipe 2 by means of ball bearings 10, for example. In the housing 5, coils 11 are then provided, which are capable of driving the drum 9 to rotate. Tests have shown that the activation of the carbon atoms increases if three pairs of magnets 3 rotate around the pipe 2 while the fuel is flowing. A controller 12 controls the speed of rotation of the drum 9 via the coils 11. The drum 9 need not be driven by the coils 11. Alternatives such as electric motors or the like are equally possible.

Because the magnets 3 are located in the drum 9, they are still always positioned inside the housing 5. The housing 5 now takes on the function of mechanically protecting the rotating drum 9 and optionally of receiving parts of the drive means for the drum 9. However, in this embodiment the housing 5 could be varied in its construction, for instance in the direction of a mesh basket or guard braces.

FIG. 6 shows this embodiment in cross section along the line AB in FIG. 5. Either more or fewer than the six coils 11 shown in FIG. 5 may be used. Moreover, they need not be located at the level of the magnets 3. The magnetic field generated by the coils 11 should be selected such that safe, fast driving of the drum 9 is assured, yet the magnetic field generated by the magnets 3 in the pipe 2 remains unchanged.

The controller 12 can regulate the rotary speed of the drum 9 also as a function of the actually achieved or desired activation of the carbon atoms. To that end, at least one sensor 13 is mounted at the fluid outlet from the pipe 2 of the device 1; this sensor measures the activation and forwards it to the controller via a line 14. Such a sensor 13 may comprise an LED and a photovoltaic cell. The LED then emits electromagnetic radiation at a defined frequency, such as the resonant frequency of carbon, and the photovoltaic cell receives the then-emitted electromagnetic radiation from the carbon atoms. At the inlet side of the pipe 2, sensors 13 may also be located, in order to be able to measure the difference in excitation. The best rotary speed of the drum 9 may vary as a result of changes in the composition or temperature of the fluid. The flow speed also plays a role. In engines, for instance, it can vary if a vehicle's travel speed or performance changes.

The device is suitable for the activation of diesel, gasoline, kerosene, heating oil, heavy oil, vegetable oils, and so forth, as well as for gases, such as camping gas, butane, propane, etc. The increase in efficiency depends selectively in the increase in the power of an engine, whose fuel supply line is equipped with a device 1, or as a result of the reduction in fuel consumption for the same performance. It is understood that the efficiency also increases in heaters or burners. In addition, enhanced efficiency is directly expressed in the reduction in the proportion of soot or of carbon monoxide in the exhaust gases.

1. A device for a magnetic treatment of a hydrocarbon-containing fluid, which device has a pipe for the fluid to flow through and six magnets, which form three pairs located one after the other, the magnetic fields of which penetrate the interior of the pipe, wherein the magnets are essentially cylindrical and are located outside the pipe, the two magnets of one pair being located in alignment with one another on opposite sides of the pipe wall and each pointing with one of its face ends to the pipe, and each magnet having a line pattern of alternating magnetic polarization, which is oriented perpendicular to the flow direction of the fluid.

2. The device of claim 1, comprising at least one further group of three pairs of magnets.

3. The device of claim 1, wherein the magnets are located in a housing.

4. The device of claim 1, wherein the magnets are fixed in their position with plastic pieces.

5. The device of claim 1, wherein the axes of two pairs of magnets located one behind the other, as viewed in the flow direction, form an angle.

6. The device of claim 1, wherein the magnets are located in a drum, which is supported axially rotatably on the pipe, the drum being connected to an electric drive.

7. The device of claim 6, wherein the drive of the drum is regulated by a controller.

8. The device of claim 7, wherein the controller is connected to at least one sensor, with which the activation of the fluid is measurable.

9. The device of claim 3, wherein said housing is tubular.
